(19) United States
(12) Patent Application Publication
(10) Pub. No.: US 2021/0009827 A1
(43) Pub. Date: Jan. 14, 2021

(54) SOLVENT-BASED INK COMPOSITION

(71) Applicant: Seiko Epson Corporation, Tokyo (JP)

(72) Inventor: Hiroshi TAKIGUCHI, Matsumoto (JP)

(21) Appl. No.: 16/923,201

(22) Filed: Jul. 8, 2020

(30) Foreign Application Priority Data
Jul. 9, 2019 (JP) 2019-127464

(51) Int. Cl. C09D 11/322; C09D 11/36; C09D 11/037; C09D 11/033

(52) U.S. Cl. CPC C09D 11/322; C09D 11/033; C09D 11/037; C09D 11/36

(57) ABSTRACT

A solvent-based ink composition contains: a luster pigment; a first solvent having a boiling point of 200° C. or lower and a surface tension γ₁ of 28.0 mN/m or less; a second solvent having a boiling point of higher than 200° C. and a surface tension γ₂ of more than 28.0 mN/m; and one or more third solvents having a boiling point of higher than 200° C. and a surface tension γ₃ of 28.0 mN/m or less; where a content of the third solvents is 5.0% by mass or more and 92.0% by mass or less based on a total content of the second solvent and the third solvents.

The present application is based on, and claims priority from JP Application Serial Number 2019-127464, filed Jul. 9, 2019, the disclosure of which is hereby incorporated by reference herein in its entirety.

### BACKGROUND

### 1. Technical Field

The present disclosure relates to a solvent-based ink composition.

### 2. Related Art

An ink jet recording method enables recording of high-resolution images by using a relatively simple apparatus and thus has been rapidly developing in various fields. Under such circumstances, various studies are underway to obtain high-quality printed articles in a further stable manner.

For the purpose of providing a solvent-based ink composition excellent in discharge stability when discharged by an ink jet method, JP-A-2018-111767, for example, describes a solvent-based ink composition containing an organic solvent, a surface-treated metal powder, and a polyoxyethylene alkyl ether phosphate compound, where: the content of the polyoxyethylene alkyl ether phosphate compound is 0.1% by mass or more and 10.0% by mass or less based on the total amount of ink; and the surface-treated metal powder contains aluminum or an aluminum alloy and is surface-treated with a fluorine-based compound as a surface treatment agent.

A solvent-based ink composition containing a luster pigment, such as aluminum, described in JP-A-2018-111767 is used to form an image with metallic luster and is required to enable printing of an image with high metallic luster at a high resolution in a stable manner. As an indicator of uniform and stable printing, such a solvent-based ink composition is required to prevent the occurrence of uneven luster even in a high-density printing pattern with a duty of 80% to 100%.

Moreover, a solvent-based ink composition that forms an image by an ink jet method is characterized by being capable of forming a lustrous narrow line pattern. However, solvent-based ink compositions of related art have a problem with pattern forming properties in formation of a narrow line pattern, such as expansion of the line width of the narrow line pattern or formation of small concavo-convex portions at the edges of the narrow line pattern.

To clarify the factors that affect such uneven luster and pattern forming properties, the present inventors observed under a microscope one dot (hereinafter, also referred to as “dot unit”) among dots formed by discharging an ink composition containing a luster pigment by an ink jet method. As a result, the luster pigment was observed to be concentrated at the outer edge relative to the central part of the dot unit, revealing the occurrence of the so-called coffee stain effect.

### SUMMARY

The present inventors conducted intensive studies to resolve the above-mentioned problems. As a result, it was found that a solvent-based ink composition that contains a luster pigment and that suppresses the coffee stain effect, reduces uneven luster of images, and exhibits excellent pattern forming properties can be obtained by including predetermined amounts of a plurality of solvents each having predetermined boiling point and surface tension.

Specifically, the present disclosure relates to a solvent-based ink composition containing: a luster pigment; a first solvent having a boiling point of 200° C. or lower and a surface tension γ₁ of 28.0 mN/m or less; a second solvent having a boiling point of higher than 200° C. and a surface tension γ₂ of more than 28.0 mN/m; and one or more third solvents having a boiling point of higher than 200° C. and a surface tension γ₃ of 28.0 mN/m or less; where a content of the third solvents is 5.0% by mass or more and 92.0% by mass or less based on a total content of the second solvent and the third solvents.

A solvent-based ink composition of the present disclosure is preferably the following embodiment, for example.

The third solvents may include one or more selected from the group consisting of ethylene glycol mono-2-ethylhexyl ether, diethylene glycol monohexyl ether, diethylene glycol mono-2-ethylhexyl ether, dipropylene glycol monobutyl ether, and tripropylene glycol monomethyl ether.

The luster pigment may contain aluminum. Moreover, the luster pigment may have a volume-average particle size D₅₀ of 0.2 μm or more and 1.0 μm or less.

The surface tension γ₃ of the third solvents may be smaller than the surface tension γ₁ of the first solvent. The boiling point BP₃ of the third solvents may be higher than the boiling point BP₂ of the second solvent. A difference |γ₁−γ₃| between the surface tension γ₁ of the first solvent and the surface tension γ₃ of the third solvents may be 3.5 mN/m or less. A difference (γ₂−γ₁) between the surface tension γ₂ of the second solvent and the surface tension γ₁ of the first solvent may be 3.0 mN/m or more. A difference (γ₂−γ₃) between the surface tension γ₂ of the second solvent and the surface tension γ₃ of the third solvent may be 5.0 mN/m or more. A difference (BP₂−BP₁) between the boiling point BP₂ of the second solvent and the boiling point BP₁ of the first solvent may be 50.0° C. or more. A difference (BP₃−BP₁) between the boiling point BP₃ of the third solvents and the boiling point BP₁ of the first solvent may be 30.0° C. or more.

### DESCRIPTION OF EXEMPLARY EMBODIMENTS

Hereinafter, an embodiment of the present disclosure (hereinafter, referred to as “present embodiment”) will be described in detail. However, the present disclosure is not limited to such an embodiment, and various modifications are possible without departing from the gist of the present disclosure.

### Solvent-Based Ink Composition

A solvent-based ink composition of the present embodiment (hereinafter, also simply referred to as “ink composition”) contains: a luster pigment; a first solvent having a boiling point of 200° C. or lower and a surface tension γ₁ of 28.0 mN/m or less (hereinafter, also simply referred to as “first solvent”); a second solvent having a boiling point of higher than 200° C. and a surface tension γ₂ of more than 28.0 mN/m (hereinafter, also simply referred to as “second solvent”); and one or more third solvents having a boiling point of higher than 200° C. and a surface tension γ₃ of 28.0 mN/m or less (hereinafter, also simply referred to as “third solvent”).

In the ink composition of the present embodiment, a content of the third solvents is 5.0% by mass or more and 92.0% by mass or less based on a total content of the second solvent and the third solvents.

According to the above-described ink composition of the present embodiment, the coffee stain effect is suppressed in dot units formed by an ink jet method. Moreover, according to the ink composition of the present embodiment, uneven luster is reduced in formation of high-duty images. Further, the ink composition of the present embodiment suppresses, in formation of a narrow line pattern, expansion of the line width and formation of concavo-convex portions at the pattern edges and thus exhibits excellent pattern forming properties.

The reasons why these effects can be obtained are not clear but are presumably as follows. When printing is performed by an ink jet method, innumerable dots are generally formed on a recording medium. By focusing on one of these dots, the formation process will be microscopically and chronologically considered. First, an ink composition is discharged from nozzles and allowed to impact a recording medium, thereby forming droplets of the ink composition on the surface of the recording medium. Each droplet has a shape rising in the central part due to the surface tension of liquid components of the ink composition. A drying process until a dry dot is obtained from the droplet will now be considered chronologically. The droplet is dried first at the outer edge of a thin liquid film through volatilization of the liquid components, then in the central part of a thick liquid film through volatilization of the liquid components, thereby forming a dry dot. In a dot formed from an ink composition of related art, the coffee stain effect is observed through concentration of a luster pigment at the outer edge that is dried earlier. Accordingly, a driving force is considered to exist to move the luster pigment to the outer edge in the drying process. Factors that the drying process affects the coffee stain effect include (i) formation of a surface tension gradient based on a temperature gradient within a droplet and (ii) formation of a surface tension gradient based on the compositional change of liquid components.

First, (i) will be considered. In general, when a liquid volatilizes, the temperature decreases due to the heat of vaporization. Since the outer edge of a droplet has a thin liquid film and a large surface area relative to the volume of the region, the temperature tends to decrease when liquid components on the surface volatilize. In contrast, since the central part of a droplet has a thick liquid film and a small surface area relative to the volume of the region, the temperature is less likely to decrease even when liquid components on the surface volatilize. As a result, in the drying process, the central part of a droplet has a relatively high temperature whereas the outer edge of the droplet has a relatively low temperature, thereby forming a temperature gradient within the droplet. When the temperature of a liquid decreases, the surface tension tends to increase. For this reason, it is presumed that a surface tension gradient is formed within a droplet due to a temperature gradient within the droplet, thereby moving a luster pigment to the outer edge with a higher surface tension.

Next, (ii) will be considered. In general, a compound having a lower boiling point volatilizes earlier in a liquid composition. When a solvent having a low boiling point and a low surface tension is contained in an ink composition, the solvent having a low surface tension preferentially volatilizes at the outer edge of a droplet, thereby increasing the surface tension. For this reason, it is presumed that a surface tension gradient is formed within the droplet due to volatilization of liquid components, thereby moving a luster pigment to the outer edge of the droplet.

In view of the above consideration, the composition of solvents in an ink composition was investigated. Consequently, it was found that the coffee stain effect is suppressed, uneven luster of images is reduced, and excellent pattern forming properties are exhibited by including a first solvent, a second solvent, and a third solvent in the ink composition. The first solvent having a low surface tension and a relatively low boiling point readily volatilizes. Meanwhile, the second solvent having a high surface tension and a relatively high boiling point is less likely to volatilize. When the third solvent having a low surface tension and a relatively high boiling point is contained in addition to the first solvent and the second solvent, the presence of the third solvent having a low surface tension reduces local lowering in surface tension of the ink composition even after volatilization of the first solvent. As a result, the formation of a surface tension gradient due to the effect of (ii) above is suppressed. Moreover, by including the third solvent having a relatively high boiling point, the volatilization rate of liquid components slows down and a temperature gradient within droplets is less likely to be formed. Consequently, the formation of a surface tension gradient due to the effect of (i) above is also suppressed. For these reasons, an ink composition of the present embodiment is considered to suppress the coffee stain effect, reduce uneven luster, and exhibit excellent pattern forming properties. Here, the consideration about the mechanisms is described, but the reasons for attainment of an object in the present disclosure are not limited to these mechanisms.

### Luster Pigments

A luster pigment acts to impart luster to a pattern formed through attachment to a recording medium. Examples of the luster pigment include, but are not particularly limited to, metal pigments and pearlescent pigments. These luster pigments may be used alone or in combination.

Exemplary metal pigments include, but are not particularly limited to, particles of aluminum, silver, gold, platinum, nickel, chromium, tin, zinc, indium, titanium, copper, and so forth; particles of alloys thereof; and mixtures thereof.

Exemplary pearlescent pigments include, but are not particularly limited to, pigments having pearly luster and/or interference colors, such as titanium dioxide-coated mica, fish scale foil, and bismuth oxychloride.

Exemplary shapes of the luster pigment include, but are not particularly limited to, tabular, spherical, spindle, and needle shapes. Among these shapes, a tabular shape is preferable. When a luster pigment has a tabular shape, it is possible to arrange the luster pigment on a recording medium, to which an ink composition is attached, such that the principal surface conforms to the surface shape of the recording medium. Consequently, luster and the like that the luster pigment intrinsically has can be further effectively exhibited.

In the present embodiment, the term “tabular shape” means a shape in which an area observed from a predetermined angle (in a plan view) is larger than an area observed from an angle orthogonal to the above-mentioned observation direction. In the shape of each metal particle, a ratio (S₁/S₀) of a maximum projected area S₁ [μm²] to a maximum orthogonal area S₀ [μm²] is preferably 2.0 or more, more preferably 5.0 or more, and further preferably 8.0 or more. Here, the maximum projected area means an area in a plan view observed from a direction in which a projected area becomes maximum. The maximum orthogonal area means an area in a plan view observed from a direction in which an area becomes maximum among directions orthogonal to the observation direction for the maximum projected area. As these values, for example, averages of values calculated by observing any 10 particles may be employed.

The luster pigment of the present embodiment preferably contains aluminum. Aluminum is excellent in luster of a printed image obtained from an ink composition as well as in raw material cost. Here, the luster pigment may contain at least aluminum and may further contain other metals.

The luster pigment of the present embodiment is preferably metal particles. The metal particles may be any particle at least whose region including the surface and the vicinity thereof is formed from a metal or a metal alloy (hereinafter, also simply referred to as “metal”). Such metal particles may be those entirely formed from a metal or may be those having a nonmetal material core and a metal coating film that covers the core, for example.

Metal particles as a luster pigment may be manufactured by any method. However, the metal particles are preferably obtained, for example, by forming a metal film on either surface of a sheet substrate by vapor deposition, subsequently releasing the metal film from the sheet substrate, and pulverizing. In place of vapor deposition, ion plating or sputtering may be employed. Since tabular metal particles are obtained by this method, it is possible to further effectively exhibit luster and the like that the metal particles intrinsically have.

Such sheet substrates are not particularly limited, and plastic films of polyethylene terephthalate and so forth may be used, for example. Moreover, a release agent, such as a silicone oil, may be applied to or a resin release layer may be formed on a film-forming surface of a sheet substrate in advance to improve releasability. Exemplary resins used for the resin release layer include, but are not particularly limited to, polyvinyl alcohol, polyvinyl butyral, polyethylene glycol, polyacrylic acid, polyacrylamide, cellulose derivatives, such as cellulose acetate butyrate, and modified nylon resins. The releasing and pulverizing are performed, for example, in a nonaqueous medium by irradiating the metal film with ultrasound or applying an external force through stirring by a homogenizer or the like.

Examples of the nonaqueous medium used for the releasing and pulverizing include, but are not particularly limited to, alcohol solvents, hydrocarbon solvents, and ether solvents. Among these solvents, ether solvents are preferable. Exemplary ether solvents include, but are not particularly limited to, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, diethylene glycol monobutyl ether acetate, diethylene glycol n-butyl ether, tripropylene glycol dimethyl ether, triethylene glycol diethyl ether, propylene glycol monomethyl ether acetate, 1,2-dimethoxyethane, bis(2-methoxyethyl) ether, and p-dioxane. Among these ether solvents, diethylene glycol dimethyl ether, diethylene glycol diethyl ether, and diethylene glycol methyl ethyl ether are preferable, and diethylene glycol diethyl ether is more preferable.

### Surface Treatment Agents

The luster pigment is preferably metal particles treated with a surface treatment agent. Examples of the surface treatment agent include, but are not particularly limited to, fluorine-based compounds. Exemplary fluorine-based compounds include, but are not particularly limited to, fluorinated phosphonic acids, fluorinated carboxylic acids, fluorinated sulfonic acids, fluorinated silanes, and salts thereof. Since these fluorine-based compounds can form coating films through bonding with the surfaces of metal particles, it is possible to obtain water resistance-imparted metal particles. Consequently, it is possible to effectively suppress reactions of the metal particles with water and to obtain a metal pigment dispersion with excellent dispersibility. Among these compounds, fluorinated phosphonic acids and salts thereof are more preferable due to particularly excellent bonding ability with metal particle surfaces.

Exemplary fluorinated phosphonic acids and salts thereof includes, but are not particularly limited to, compounds represented by the following formula (1).

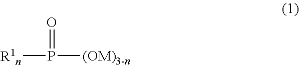

In formula (1), one or a plurality of R¹ are each independently one group selected from the structural formulae below; one or a plurality of M are each independently a hydrogen atom, a hydrocarbon group, a monovalent metal ion, ammonium ion, or —NR²R³R⁴; R², R³, and R⁴ are each independently a hydrogen atom or a C₂H₄OH group while excluding a case in which all of R² R³, and R⁴ are a hydrogen atom; n is an integer of 1 or more and 3 or less. In each of the following structural formulae, m is an integer of 1 or more and 12 or less; and l is an integer of 1 or more and 12 or less.

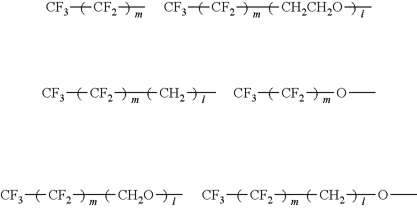

In each structural formula above, m is preferably an integer of 1 or more and 8 or less and more preferably an integer of 1 or more and 5 or less. Moreover, 1 is preferably an integer of 1 or more and 10 or less and more preferably an integer of 1 or more and 6 or less. When m and 1 fall within the above-mentioned preferable ranges, the foregoing effects are further remarkably exerted.

The above-mentioned fluorinated phosphonic acids are preferably compounds represented by the following formula (2) from a viewpoint of achieving excellent adsorption ability onto metal particle surfaces.

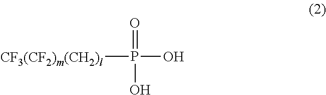

In formula (2) above, m is an integer of 1 or more and 12 or less, preferably an integer of 1 or more and 8 or less, and more preferably an integer of 1 or more and 5 or less. Moreover, l is an integer of 1 or more and 12 or less, preferably an integer of 1 or more and 10 or less, and more preferably an integer of 1 or more and 6 or less. When m and l fall within the above-mentioned preferable ranges, the foregoing effects are further remarkably exerted.

Exemplary fluorinated carboxylic acids and salts thereof include, but are not particularly limited to, compounds represented by the following formula (3).

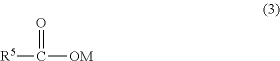

In formula (3) above, R⁵ is one group selected from the structural formulae below; and M is a hydrogen atom, a monovalent metal ion, or ammonium ion. In each of the following structural formulae, m is an integer of 1 or more and 12 or less, preferably an integer of 1 or more and 8 or less, and more preferably an integer of 1 or more and 5 or less. Moreover, l is an integer of 1 or more and 12 or less, preferably an integer of 1 or more and 10 or less, and more preferably an integer of 1 or more and 6 or less.

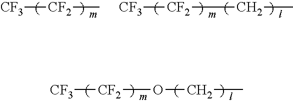

Exemplary fluorinated sulfonic acids and salts thereof include, but are not particularly limited to, compounds represented by the following formula (4).

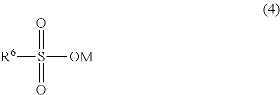

In formula (4) above, R⁶ is one group selected from the structural formulae below; and M is a hydrogen atom, a monovalent metal ion, or ammonium ion. In each of the following structural formulae, m is an integer of 5 or more and 17 or less; and l is an integer of 1 or more and 12 or less.

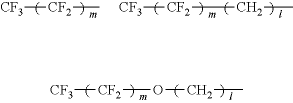

Further, such a fluorine-based compound preferably has a perfluoroalkyl group (CₙF₂ₙ₊₁) in at least part of its structure, and the perfluoro alkyl group more preferably has 1 to 6 carbon atoms. When a fluorine-based compound has such a structure, metal particles with excellent luster and dispersibility are readily obtained. Consequently, the image quality of recorded images tends to be enhanced.

The amount of a surface treatment agent added is preferably 1 part by mass or more and 50 parts by mass or less, more preferably 2 parts by mass or more and 40 parts by mass or less, and further preferably 4.5 parts by mass or more and 30 parts by mass or less based on 100 parts by mass of metal particles. By controlling the amount of a surface treatment agent added within these ranges, the foregoing effects of the present embodiment tend to be exerted further effectively.

Metal particles to be treated with a surface treatment agent as described above are preferably brought into contact with an acid or a base in advance. As a result, it is possible to further reliably modify metal particle surfaces through chemical bonding with the surface treatment agent. Accordingly, the foregoing effects of the present disclosure tend to be exerted further effectively. Examples of the acid include, but are not particularly limited to, protonic acids, such as hydrochloric acid, sulfuric acid, phosphoric acid, nitric acid, acetic acid, carbonic acid, formic acid, benzoic acid, chlorous acid, hypochlorous acid, sulfurous acid, dithionous acid, nitrous acid, hyponitrous acid, phosphorous acid, and phosphinic acid. Among these acids, hydrochloric acid, phosphoric acid, or acetic acid is preferable. Examples of the base include, but are not particularly limited to, sodium hydroxide, potassium hydroxide, and calcium hydroxide. Among these bases, sodium hydroxide or potassium hydroxide is preferable.

The luster pigment has an average thickness of preferably 10 nm or more and 90 nm or less, more preferably 12 nm or more and 60 nm or less, and further preferably 14 nm or more and 35 nm or less. As a result, the effects of the luster pigment being tabular particles are further remarkably exerted.

Here, the average thickness of the luster pigment is measured by using an atomic force microscope (hereinafter, also referred to as “AFM”) in the following procedure. Exemplary atomic force microscopes include “NX20” from Park Systems Corp. First, a sample for AFM measurement is prepared by applying, to a silicon substrate, a luster pigment dispersed with a low-boiling solvent, such as acetone, to align the luster pigment particles in a dry state separately without aggregation on the substrate surface; and drying at 100° C. for 20 minutes or more. Subsequently, concavo-convex images are obtained for 50 independent luster pigment particles by AFM measurement. The thickness of each luster pigment particle is determined as height data on the cross-section, and an average in the thickness distribution after excluding the top and bottom 10% extreme values is regarded as an average thickness.

The luster pigment has a volume-average particle size D₅₀ of preferably 0.20 μm or more and 1.00 μm or less, more preferably 0.30 μm or more and 0.80 μm or less, and further preferably 0.40 μm or more and 0.60 μm or less. When the volume-average particle size D₅₀ is 1.00 μm or less, it is possible to stabilize ink jet discharge of ink; significantly reduce ink jet failure, such as bending or missing; and perform uniform printing without unevenness. As a result, it is possible to realize, using a small amount of ink, luster of a printed article produced by using an ink composition in excellent image quality. Meanwhile, when the volume-average particle size D₅₀ is 0.20 μm or more, luster of images tends to be enhanced. This is because the above-mentioned S₁/S₀ ratio of a tabular luster pigment increases as the volume-average particle size D₅₀ of the luster pigment increases, thereby facilitating regular alignment of the luster pigment parallel to a printing surface while suppressing lowering in luster due to scattering.

The volume-average particle size D₅₀ of a luster pigment is calculated as an average of four measurement results obtained by dispersing the luster pigment with optimal times (2,000 times, for example) of diethylene glycol diethyl ether and circulating the resulting solution within a channel of a laser diffraction/scattering-type particle size analyzer. Exemplary analyzers include “Microtrac MT-3000” (from Nikkiso Co., Ltd.).

The content of a luster pigment is preferably 0.2% by mass or more and 40.0% by mass or less, more preferably 0.5% by mass or more and 10.0% by mass or less, further preferably 1.0% by mass or more and 5.0% by mass or less, still further preferably 1.2% by mass or more and 2.5% by mass or less, and still more preferably 1.4% by mass or more and 2.5% by mass or less based on the total mass of an ink composition. By controlling the content of the luster pigment within these ranges, it is possible to improve pattern forming properties.

### Solvents

An ink composition of the present embodiment contains, as solvents, a first solvent, a second solvent, and a third solvent. By combining these solvents, the ink composition of the present embodiment suppresses the coffee stain effect in dot units formed by an ink jet method, reduces uneven luster in formation of high-duty images, and exhibits excellent pattern forming properties.

In the present embodiment, the “boiling point” means a boiling point at normal pressure (780 mmHg).

Regarding differences in boiling point between various solvents described hereinafter, such as a difference (BP₂−BP₁) and a difference (BP₃−BP₁), when any of the categories of the first solvent, the second solvent, and the third solvent includes two or more solvents, the boiling point of a solvent of the highest content among two or more of the solvents is used as a boiling point of the corresponding type of solvents for calculation. Here, if a plurality of “solvents of the highest content” exist, the boiling point of a solvent that results in the largest difference in boiling point is used for calculation.

In the present embodiment, the “surface tension” is a value measured using a surface tensiometer by the Wilhelmy method at a liquid temperature of 25° C. Exemplary surface tensiometers include a fully automatic surface tensiometer “CBVP-Z” (from Kyowa Interface Science Co., Ltd.).

Regarding differences in surface tension between various solvents described hereinafter, such as a difference (γ₂−γ₁), a difference (γ₂−γ₃), and a difference |γ₁−γ₃|, when any of the categories of the first solvent, the second solvent, and the third solvent includes two or more solvents, a weighted mean of surface tensions calculated from the contents and surface tensions of the respective two or more solvents is used for calculation as the surface tension value of the corresponding type of solvents.

### First Solvents

The first solvent has a boiling point of 200° C. or lower and a surface tension γ₁ of 28.0 mN/m or less. Examples of the first solvent include, but are not particularly limited to, diethylene glycol diethyl ether (boiling point: 189° C., surface tension: 26.9 mN/m), diethylene glycol ethyl methyl ether (boiling point: 176° C., surface tension: 27.5 mN/m), ethylene glycol dimethyl ether (boiling point: 84° C., surface tension: 23.5 mN/m), ethylene glycol diethyl ether (boiling point: 121° C., surface tension: 24.5 mN/m), diethylene glycol dimethyl ether (boiling point: 162° C., surface tension: 25.6 mN/m), ethylene glycol monomethyl ether (boiling point: 124° C., surface tension: 27.7 mN/m), ethylene glycol monoisopropyl ether (boiling point: 144° C., surface tension: 27.8 mN/m), and ethylene glycol monobutyl ether (boiling point: 171° C., surface tension: 27.7 mN/m). These first solvents may be used alone or in combination. Among these solvents, diethylene glycol diethyl ether or diethylene glycol ethyl methyl ether is preferable.

The content of the first solvent is preferably 30.0% by mass or more and 95.0% by mass or less, more preferably 50.0% by mass or more and 90.0% by mass or less, and further preferably 60.0% by mass or more and 90.0% by mass or less based on the total mass of an ink composition. By controlling the content of the first solvent within these ranges, it is possible to improve image quality of printed articles.

### Second Solvents

The second solvent has a boiling point of higher than 200° C. and a surface tension γ₂ of more than 28.0 mN/m. The ink composition of the present embodiment exhibits excellent pattern forming properties by including the second solvent.

A difference (BP₂−BP₁) between the boiling point BP₂ of the second solvent and the boiling point BP₁ of the first solvent is preferably 50.0° C. or more, more preferably 55.0° C. or more, and further preferably 60.0° C. or more. When the difference (BP₂−BP₁) is 50.0° C. or more, the coffee stain effect and uneven luster of images tend to be further suppressed and further excellent pattern forming properties tend to be exhibited. Meanwhile, the difference (BP₂−BP₁) is preferably 120.0° C. or less, more preferably 100.0° C. or less, and further preferably 95.0° C. or less. When the difference (BP₂−BP₁) is 120.0° C. or less, the coffee stain effect is readily suppressed.

A difference (γ₂−γ₁) between the surface tension γ₂ and the surface tension γ₁ is preferably 1.5 mN/m or more, more preferably 2.0 mN/m or more, further preferably 2.5 mN/m or more, further preferably 3.0 mN/m or more, still further preferably 3.5 mN/m or more, and still more preferably 4.0 mN/m or more. When the difference (γ₂−γ₁) is 1.5 mN/m or more, the surface tension of an ink composition as a whole is lowered, a liquid film of each droplet that has been allowed to impact a recording medium becomes thin, and localization of a luster pigment due to chronological changes in the drying process is prevented. As a result, the coffee stain effect is readily suppressed. Meanwhile, the difference (γ₂−γ₁) is preferably 10.0 mN/m or less, more preferably 8.0 mN/m or less, and further preferably 6.0 mN/m or less. When the difference (γ₂−γ₁) is 10.0 mN/m or less, the surface tension of an ink composition as a whole is lowered; a surface tension gradient within each droplet, which has been allowed to impact a recording medium, due to chronological changes in the drying process of the droplet is less likely to be formed; and localization of a luster pigment is prevented. As a result, the coffee stain effect is readily suppressed.

Examples of the second solvent include, but are not particularly limited to, tetraethylene glycol monobutyl ether (boiling point: 304° C., surface tension: 39.0 mN/m), triethylene glycol monobutyl ether (boiling point: 271° C., surface tension: 30.0 mN/m), triethylene glycol monomethyl ether (boiling point: 249° C., surface tension: 31.9 mN/m), diethylene glycol monoethyl ether (boiling point: 202° C., surface tension: 31.3 mN/m), diethylene glycol isopropyl ether (boiling point: 207° C., surface tension: 29.9 mN/m), and 1,3-butylene glycol (boiling point: 208° C., surface tension: 36.1 mN/m). These second solvents may be used alone or in combination. Among these solvents, triethylene glycol monobutyl ether or triethylene glycol monomethyl ether is preferable.

The content of the second solvent is preferably 4.9% by mass or more and 60.0% by mass or less, more preferably 9.9% by mass or more and 49.9% by mass or less, and further preferably 9.9% by mass or more and 40.0% by mass or less based on the total mass of an ink composition. By controlling the content of the second solvent within these ranges, the ink composition tends to further suppress the coffee stain effect and uneven luster of images as well as exhibit further excellent pattern forming properties.

### Third Solvents

The third solvent has a boiling point of higher than 200° C. and a surface tension γ₃ of 28.0 mN/m or less. By including the third solvent in an ink composition, formation of a temperature gradient or a surface tension gradient within each droplet of the ink composition that has been allowed to impact a recording medium is suppressed in the drying process of the droplet. As a result, the ink composition tends to further suppress the coffee stain effect and uneven luster of images as well as exhibit further excellent pattern forming properties.

The boiling point BP₃ of the third solvent is preferably higher than the boiling point BP₂ of the second solvent. As a result, since the third solvent volatilizes after the second solvent in the drying process of droplets of an ink composition that has been allowed to impact a recording medium, changes in surface tension within each droplet due to volatilization of the first solvent is reduced. Consequently, the ink composition tends to further suppress the coffee stain effect and uneven luster of images as well as exhibit further excellent pattern forming properties.

A difference (BP₃−BP₁) between the boiling point BP₃ of the third solvent and the boiling point BP₁ of the first solvent is preferably 30.0° C. or more, more preferably 40.0° C. or more, and further preferably 60.0° C. or more. When the difference (BP₃−BP₁) is 30.0° C. is more, the volatilization rate of the third solvent becomes slower than the volatilization rate of the first solvent. For this reason, the third solvent suppresses formation of a temperature gradient or a surface tension gradient due to volatilization of the first solvent. Consequently, the ink composition tends to further suppress the coffee stain effect and uneven luster of images as well as exhibit further excellent pattern forming properties. Meanwhile, the difference (BP₃−BP₁) is preferably 120° C. or less, more preferably 110° C. or less, and further preferably 100° C. or less. When the difference (BP₃−BP₁) is 120° C. or less, the ink composition tends to further suppress the coffee stain effect and uneven luster of images as well as exhibit further excellent pattern forming properties.

The surface tension γ₃ of the third solvent is preferably smaller than the surface tension γ₁ of the first solvent. By satisfying this relationship, it is possible to reduce changes in surface tension due to volatilization of the first solvent without using a large amount of the third solvent. Consequently, the ink composition tends to further suppress the coffee stain effect and uneven luster of images as well as exhibit further excellent pattern forming properties.

A difference |γ₁−γ₃| between the surface tension γ₁ and the surface tension γ₃ is preferably 3.5 mN/m or less, more preferably 3.0 mN/m or less, preferably 2.0 mN/m or less, more preferably 1.8 mN/m or less, and further preferably 1.4 mN/m or less. Meanwhile, the difference |γ₁−γ₃| is not particularly limited but is 0.2 mN/m or more, for example. When the difference |γ₁−γ₃| falls within these ranges, changes in surface tension within each droplet due to volatilization of the first solvent are reduced. Consequently, the ink composition tends to further suppress the coffee stain effect and uneven luster of images as well as exhibit further excellent pattern forming properties.

A difference (γ₂−γ₃) between the surface tension γ₂ and the surface tension γ₃ is preferably 3.0 mN/m or more, more preferably 3.5 mN/m or more, further preferably 4.0 mN/m or more, still further preferably 5.0 mN/m or more, still more preferably 5.4 mN/m or more, and particularly preferably 6.0 mN/m or more. By satisfying this relationship, it is possible to reduce changes in surface tension due to volatilization of the first solvent without using a large amount of the third solvent. Consequently, the ink composition tends to further suppress the coffee stain effect and uneven luster of images as well as exhibit further excellent pattern forming properties. Meanwhile, the difference (γ₂−γ₃) is preferably 10.0 mN/m or less, more preferably 8.0 mN/m or less, and further preferably 6.3 mN/m or less. When the difference (γ₂−γ₃) is 10.0 mN/m or less, the ink composition tends to further suppress the coffee stain effect and uneven luster of images as well as exhibit further excellent pattern forming properties.

Examples of the third solvent include, but are not particularly limited to, diethylene glycol mono-2-ethylhexyl ether (boiling point: 272° C., surface tension: 25.6 mN/m), ethylene glycol mono-2-ethylhexyl ether (boiling point: 250° C., surface tension: 25.4 mN/m), dipropylene glycol monobutyl ether (boiling point: 230° C., surface tension: 23.7 mN/m), tripropylene glycol monomethyl ether (boiling point: 243° C., surface tension: 25.7 mN/m), and diethylene glycol monohexyl ether (boiling point: 259° C., surface tension: 26.0 mN/m). These third solvents may be used alone or in combination. The third solvents preferably include one or more selected from the group consisting of ethylene glycol mono-2-ethylhexyl ether, diethylene glycol monohexyl ether, diethylene glycol mono-2-ethylhexyl ether, dipropylene glycol monobutyl ether, and tripropylene glycol monomethyl ether.

The content of the third solvent is preferably 0.1% by mass or more and 30.0% by mass or less, more preferably 0.5% by mass or more and 25.0% by mass or less, and further preferably 1.0% by mass or more and 20.0% by mass or less based on the total mass of an ink composition. By controlling the content of the third solvent within these ranges, the ink composition tends to further suppress the coffee stain effect and uneven luster of images as well as exhibit further excellent pattern forming properties.

The content of the third solvent in an ink composition of the present embodiment is 5.0% by mass or more and 92.0% by mass or less based on the total content of the second solvent and the third solvent. By controlling the content of the third solvent within this range, the coffee stain effect in dots is suppressed, uneven luster in formation of high-duty images is reduced, and excellent pattern forming properties are exhibited. The content of the third solvent is preferably 8.0% by mass or more, more preferably 12.0% by mass or more, and further preferably 20.0% by mass or more based on the total content of the second solvent and the third solvent. Meanwhile, the content of the third solvent is preferably 91.1% by mass or less based on the total content of the second solvent and the third solvent. By controlling within these ranges, the coffee stain effect is further remarkably suppressed, uneven luster in formation of high-duty images is further remarkably reduced, and further remarkably excellent pattern forming properties are exhibited.

The total content of the second solvent and the third solvent in an ink composition of the present embodiment is preferably 12.0% by mass or more and 30.1% by mass or less based on the total mass of the ink composition. By controlling the total content of the second solvent and third solvent within this range, the coffee stain effect in dots is suppressed, uneven luster in formation of high-duty images is reduced, and excellent pattern forming properties are exhibited. The total content of the second solvent and the third solvent is more preferably 15.0% by mass or more and further preferably 16.0% by mass or more based on the total mass of the ink composition. Meanwhile, the total content of the second solvent and the third solvent is more preferably 25.0% by mass or less and further preferably 20.0% by mass or less based on the total mass of the ink composition.

The total content of the first solvent, the second solvent, and the third solvent in an ink composition of the present embodiment is 50.0% by mass or more and 99.0% by mass or less based on the total mass of the ink composition. The total content of the first solvent, the second solvent, and the third solvent is preferably 60.0% by mass or more, more preferably 70.0% by mass or more, and further preferably 80.0% by mass or more. Meanwhile, the total content is preferably 98.8% by mass or less and more preferably 98.6% by mass or less. By controlling within these ranges, the coffee stain effect is further remarkably suppressed, uneven luster in formation of high-duty images is further remarkably reduced, and further remarkably excellent pattern forming properties are exhibited.

### Resins

An ink composition of the present embodiment may contain a resin. Examples of the resin include, but are not particularly limited to, acrylic acid resins, styrene-acrylic acid resin, styrene-maleic acid resin, rosin-modified resins, terpene resins, polyester resins, polyamide resins, epoxy resins, vinyl chloride resins, vinyl chloride-vinyl acetate copolymer resin, fiber component resins (cellulose acetate butyrate resin, hydroxypropyl cellulose resin, for example), polyvinyl butyral, polyacrylic polyols, polyvinyl alcohol, and polyurethanes. These resins may be used alone or in combination.

Exemplary commercial products of the above-mentioned cellulose acetate butyrate resin include “551-0.2” and “531-1” from Eastman Chemical Company. Exemplary commercial products of polyester resins include “Vylon 802” and “Vylon 200” from Toyobo Co., Ltd. Exemplary commercial products of acrylic acid resins include “X-310” and “VS-1028” from Seiko PMC Corporation, “UC-3000” and “GS-1015” from Toagosei Co., Ltd., “LW1000P” from Kuraray Co. Ltd., and “Paraloid B-60” from the Dow Chemical Company. Exemplary commercial products of styrene-acrylic acid resin include “X-1” from Seiko PMC Corporation. Exemplary commercial products of styrene-maleic acid resin include “X-220” from Seiko PMC Corporation. Exemplary commercial products of vinyl chloride-vinyl acetate copolymer resin include “CLL” and “CNL” from Nissin Chemical Co., Ltd. Exemplary commercial products of terpene resins include “YS Polyster G 125” from Yasuhara Chemical Co., Ltd.

If contained, the content of a resin is preferably 0.05% by mass or more and 10% by mass or less and more preferably 0.1% by mass or more and 5% by mass or less based on the total mass of an ink composition. When the resin content falls within these ranges, fixing properties of a luster pigment to a recording medium is further improved.

An ink composition of the present embodiment may contain additives, such as dyes and other colorants, surfactants, penetrating agents, humectants, dissolution aids, viscosity modifiers, pH adjusters, antioxidants, preservatives, fungicides, corrosion inhibitors, and chelating agents for scavenging metal ions that affect dispersion.

An ink composition of the present embodiment can lower the surface tension without adding a surfactant by selecting predetermined solvents as described above. Conventionally common measures to suppress uneven luster of an ink composition include addition of a surfactant, such as a silicone surfactant. However, when a solvent-based ink composition contains a surfactant, a luster pigment is not aligned satisfactorily in the drying process. Accordingly, there is a risk of failing to achieve the luster properties that the ink composition intrinsically has and thus losing luster of images. In contrast, an ink composition of the present embodiment, without using a surfactant, further remarkably suppresses the coffee stain effect, further remarkably reduces uneven luster in formation of high-duty images, and exhibits further remarkably excellent pattern forming properties. An ink composition of the present embodiment preferably does not contain a surfactant having a boiling point of 400° C. or higher or a nonvolatile surfactant. More specifically, the content of a surfactant having a boiling point of 400° C. or higher or a nonvolatile surfactant in an ink composition of the present embodiment is preferably 5.0% by mass or less and 0.0% by mass or more, more preferably 1.0% by mass or less and 0.0% by mass or more, and further preferably 0.2% by mass or less and 0.0% by mass or more. When the surfactant content is a predetermined value or less as described above, bleeding is less likely to arise when an ink composition containing a luster pigment comes into contact with a color ink composition of another tone. Moreover, when a metallic color is expressed by further printing using a color ink composition of another tone on a dried printed image of an ink composition containing a luster pigment as well, it is possible to enhance adhesion of images without interfering with wetting of the color ink composition by controlling the surfactant content to a predetermined value or less.

By using an ink composition of the present embodiment, it is possible to form images with metallic luster through printing on recording media by an ink jet recording method. In other words, an ink composition of the present embodiment can be used as a solvent-based ink composition for an ink jet method and further as a solvent-based metallic ink composition for an ink jet method.

### Ink Jet Recording Method

An ink jet recording method of the present embodiment includes an ink attaching step of discharging an ink composition of the present embodiment from an ink jet head, thereby attaching to a recording medium (hereinafter, also referred to as “ink attaching step”). By having this constitution, the ink jet recording method of the present embodiment suppresses the coffee stain effect in formed dots. Moreover, the ink jet recording method of the present embodiment reduces uneven luster in formation of high-duty images. Further, the ink jet recording method of the present embodiment exhibits excellent pattern forming properties by suppressing, in formation of a narrow line pattern, expansion of the line width and formation of concavo-convex portions at the pattern edges.

The recording media are not particularly limited and may be either absorbent or non-absorbent recording media, for example. The ink jet recording method of the present embodiment is widely applicable to recording media having various absorption properties from non-absorbent recording media, in which a water-soluble ink composition hardly permeates, to absorbent recording media, in which a water-soluble ink composition readily permeates. However, the ink jet recording method of the present embodiment is preferably applied to non-absorbent recording media.

Herein, the term “non-absorbent recording media” means recording media having properties of not absorbing at all or hardly absorbing an ink composition. Meanwhile, the term “absorbent recording media” means recording media having properties of absorbing an ink composition. Quantitatively, the “non-absorbent recording media” are recording media having water absorption of 10 mL/m² or less until 30 msec^{1/2} from the start of contact in the Bristow method. Meanwhile, the “absorbent recording media” are recording media having the corresponding water absorption of more than 10 mL/m². The Bristow method is described in detail in standard No. 51 “Paper and Paperboard—a test method for liquid absorption—the Bristow method” of the “JAPAN TAPPI Paper and Pulp Test methods, 2000 edition.”

Examples of the absorbent recording media include, but are not particularly limited to, plain paper, such as electrophotographic paper with high permeability of an ink composition; ink jet paper (ink jet paper having an ink absorbing layer formed from silica particles or alumina particles or an ink absorbing layer formed from a hydrophilic polymer, such as polyvinyl alcohol or polyvinylpyrrolidone); and art paper, coated paper, and cast coated paper that have relatively low ink permeability and that are used for common offset printing.

Examples of the non-absorbent recording media include, but are not particularly limited to, sheets and plates of plastics, such as polyvinyl chloride, polyethylene, polypropylene, and polyethylene terephthalate; plates of metals, such as iron, silver, copper, and aluminum; metal plates and plastic sheets produced by vapor-depositing such various metals; and plates of alloys, such as stainless steel and brass.

Among these recording media, non-absorbent recording media are preferable, sheets of plastics, such as polyvinyl chloride, polyethylene, polypropylene, and polyethylene terephthalate, are more preferable, and a polyvinyl chloride sheet is further preferable.

The ink jet recording method of the present embodiment may further include, to promote drying, a heating step of heating a recording medium before, during, and/or after recording. The heating means is not particularly limited but is preferably an apparatus that can control the temperature. Examples include a radiant heating-mode sheathed heater, a radiant heating-mode IR heater, a contact heating-mode sheet heater, and a heating apparatus using electromagnetic waves. The heating temperature is preferably 40° C. to 80° C. as the surface temperature of a recording medium. In addition, a blowing step using a fan or the like may be further included.

The ink jet recording method of the present embodiment may include publicly known steps of ink jet recording methods of related art, in addition to the above-described each step.

By the ink jet recording method of the present embodiment, it is possible to obtain recording media on which images with metallic luster are formed and thus to perform metallic printing.

### EXAMPLES

Hereinafter, the present disclosure will be further specifically described by means of Examples and Comparative Examples. However, the present disclosure is by no means limited by the following Examples.

### Manufacturing Examples 1 to 3 (Manufacture of Aluminum Particles A-1, A-2, and A-3)

### —Preparation of Pigment Dispersions—

For preparation of solvent-based ink compositions, pigment dispersions for solvent-based inks were produced. As the production method, first, a smooth-surface polyethylene terephthalate film (arithmetic-average surface roughness Ra of 0.02 μm or less) was prepared.

To either entire surface of the film, cellulose acetate butyrate (butyryl content of 35% to 39%) was then applied. Subsequently, a film of aluminum (hereinafter, also simply referred to as “aluminum film”) was formed on the cellulose acetate butyrate-coated surface by a vapor deposition method.

Next, the aluminum film-formed polyethylene terephthalate film was immersed in propylene glycol monomethyl ether acetate and irradiated with ultrasound. Consequently, a dispersion of tabular aluminum particles was obtained. The content of aluminum particles in the dispersion was 3.7% by mass. Further, the dispersion containing aluminum particles obtained as described above was subjected to centrifugal sedimentation of aluminum particles by a centrifuge (6,000 rpm×30 min), added with a glycol ether (diethylene glycol diethyl ether or diethylene glycol ethyl methyl ether) after discarding the supernatant, and irradiated with ultrasound to disperse aluminum particles again to obtain a dispersion (re-dispersed solution) having an aluminum particle content of 6.0% by mass.

Next, the glycol ether dispersion of aluminum obtained as described above was subjected to pulverizing and dispersing by a commercial circulation-mode ultrasonic homogenizer to yield a solution of finely pulverized aluminum particles.

The solution of finely pulverized aluminum particles obtained as described above was then added with 5 parts by mass of 1H,1H,2H,2H-perfluorooctanephosphonic acid based on 100 parts by mass of aluminum particles and subjected to ultrasonic irradiation at a liquid temperature of 55° C. for 3 hours, thereby surface treating aluminum particles. After final adjustment of the concentration, a dispersion containing 5.0% by mass of surface-treated fine aluminum was obtained. Aluminum particles A-1 had a volume-average particle size D₅₀ of 0.51 μm and an average thickness of 16.8 nm (dispersion medium: diethylene glycol diethyl ether). Aluminum particles A-2 had a volume-average particle size D₅₀ of 0.47 μm and an average thickness of 16.5 nm (dispersion medium: diethylene glycol ethyl methyl ether). Aluminum particles A-3 had a volume-average particle size D₅₀ of 0.81 μm and an average thickness of 19.5 nm (dispersion medium: diethylene glycol diethyl ether).

### Examples 1 to 17 and Comparative Examples 1 to 5

### Preparation of Ink Compositions

Each ink composition was obtained by mixing the respective materials in the composition shown in Table 1 below and sufficiently stirring. Specifically, each ink composition was prepared by uniformly mixing the respective materials and removing insolubles through a membrane filter having a pore size of 5 μm. The obtained ink compositions were evaluated by the evaluation methods described hereinafter.

### Ink Jet Recording Method

By discharging from the ink jet head of an ink jet printer “SC-S70650” (product name, from Seiko Epson Corporation) filled with an ink composition of each Example and Comparative Example, patterns (S dots, 720×720 dpi) for various evaluation were formed on a polyvinyl chloride sheet “TJ 5829R” (product name, from Mactac Americas, LLC.) as a recording medium. After printing, the patterns were dried under conditions described in various evaluation methods.

### Evaluation

### Suppression of the Coffee Stain Effect

By the above-mentioned ink jet recording method, images with a print duty of 20%, 30%, and 40% were formed in a 30 mm×30 mm square size as patterns for evaluation of the coffee stain effect. By selecting a low print duty of 20% to 40%, it is possible to observe the dried state of every ink droplet independently. Afterwards, the images were dried for 10 minutes by setting the drying temperature condition of a heater to 50° C. and left at room temperature (25° C.) for three days to complete drying. The patterns for evaluation of the coffee stain effect of the obtained printed articles were observed visually as well as under an optical microscope and evaluated in accordance with the following criteria.

A: uniform distribution of pigment without localization

B: slight localization of pigment

C: intense localization of pigment due to the coffee stain effect

D: highly uneven ring-like distribution of pigment with a region of very little pigment at the center

### Image Quality

The patterns for image quality evaluation of the printed articles obtained by the above-mentioned method were observed under an optical microscope and evaluated in accordance with the following criteria.

### Pattern Forming Properties

By the above-mentioned ink jet recording method, patterns with a line width of 80 μm for inspection of discharge failure due to nozzle clogging as well as patterns with line widths of 100 μm, 200 μm, 300 μm, 500 μm, and 1 mm were printed as evaluation patterns for line width and concavo-convex portions at the edges. Afterwards, the patterns were dried for 10 minutes by setting the drying temperature condition of a heater to 50° C. and left at room temperature (25° C.) for three days to complete drying. Expansion of each line width was measured at three sites under an optical microscope, and an average expansion of line widths was determined. In addition, regarding formation of edges on narrow lines, the presence or absence of concavo-convex portions due to bleeding was observed and evaluated in accordance with the following criteria.

A: 5% or less of line width expansion and clear narrow line pattern edges

B: more than 5% and 10% or less of line width expansion and clear narrow line pattern edges

C: more than 10% and 15% or less of line width expansion and small concavo-convex portions observed at narrow line pattern edges

D: more than 15% and 30% or less of line width expansion and concavo-convex portions observed at narrow line pattern edges

E: more than 30% of line width expansion and concavo-convex portions observed at narrow line pattern edges

### Suppression of Uneven Luster

By the above-mentioned ink jet recording method, images with a duty of 80%, 90%, and 100% (L dots, 720×720 dpi) were printed in a 30 mm×30 mm square size as patterns for evaluation of uneven luster. Afterwards, the images were dried for 10 minutes by setting the drying temperature condition of a heater to 50° C. and left at room temperature (25° C.) for three days to complete drying. The evaluation patterns of the obtained printed articles were observed visually as well as under an optical microscope and evaluated in accordance with the following criteria.

A: uniform luster surface on evaluation pattern without uneven luster

B: a little streak-like uneven luster due to printing observed on evaluation pattern

C: streak-like uneven luster due to printing observed on evaluation pattern

D: irregular uneven luster in addition to streak-like uneven luster due to printing observed on evaluation pattern

TABLE 1 (1/4)

| Ink composition (mass %) | | Ex. 1 | Ex. 2 | Ex. 3 | Ex. 4 | Ex. 5 | Ex. 6 |
|---|---|---|---|---|---|---|---|
| Luster | A-1 | 1.5 | 1.5 | 1.5 | 1.5 | 1.5 | 1.5 |
| pigment | A-2 | | | | | | |
| | A-3 | | | | | | |
| Resin | Acrylic resin | 0.5 | 0.5 | 0.5 | 0.5 | 0.5 | 0.5 |
| First | DEDG | 80.0 | 80.0 | 80.0 | 80.0 | 68.0 | 86.0 |
| solvent (S1) | MEDG | | | | | | |
| | Surface tension γ₁ (mN/m) | 26.9 | 26.9 | 26.9 | 26.9 | 26.9 | 26.9 |
| | Boiling point BP₁ (° C.) | 189 | 189 | 189 | 189 | 189 | 189 |
| Second | BTG | 16.9 | 14.4 | 9.0 | 1.5 | 24.0 | 9.6 |
| solvent (S2) | MTG | | | | | | |
| | Surface tension γ₂ (mN/m) | 30.0 | 30.0 | 30.0 | 30.0 | 30.0 | 30.0 |
| | Boiling point BP₂ (° C.) | 271 | 271 | 271 | 271 | 271 | 271 |
| Third | EHDG | 1.1 | 3.6 | 9.0 | 16.5 | 6.0 | 2.4 |
| solvent (S3) | EHG | | | | | | |
| | BFDG | | | | | | |
| | MFTG | | | | | | |
| | HeDG | | | | | | |
| | Surface tension γ₃ (mN/m) | 25.6 | 25.6 | 25.6 | 25.6 | 25.6 | 25.6 |
| | Boiling point BP₃ (° C.) | 272 | 272 | 272 | 272 | 272 | 272 |
| Solvent | S3/(S2 + S3)*100 | 6.1 | 20.0 | 50.0 | 91.7 | 20.0 | 20.0 |
| content | S2 + S3 | 18.0 | 18.0 | 18.0 | 18.0 | 30.0 | 12.0 |
| Difference \|γ₁ - γ₃\| | | 1.3 | 1.3 | 1.3 | 1.3 | 1.3 | 1.3 |
| Difference (γ₂ - γ₁) | | 3.1 | 3.1 | 3.1 | 3.1 | 3.1 | 3.1 |
| Difference (γ₂ - γ₃) | | 4.4 | 4.4 | 4.4 | 4.4 | 4.4 | 4.4 |
| Difference (BP₂ - BP₁) | | 82.0 | 82.0 | 82.0 | 82.0 | 82.0 | 82.0 |
| Difference (BP₃ - BP₁) | | 83.0 | 83.0 | 83.0 | 83.0 | 83.0 | 83.0 |
| Evaluation | Suppression of coffee stain effect | B | A | A | A | A | B |
| result | Pattern forming properties | A | A | B | C | C | A |
| | Suppression of uneven luster | B | B | A | A | A | B |

TABLE 1 (2/4)

| Ink composition (mass %) | | Ex. 7 | Ex. 8 | Ex. 9 | Ex. 10 | Ex. 11 | Ex. 12 |
|---|---|---|---|---|---|---|---|
| Luster | A-1 | 1.5 | 1.5 | 1.5 | 1.5 | 1.5 | 1.5 |
| pigment | A-2 | | | | | | |
| | A-3 | | | | | | |
| Resin | Acrylic resin | 0.5 | 0.5 | 0.5 | 0.5 | 0.5 | 0.5 |
| First | DEDG | | 40.0 | 80.0 | 80.0 | 80.0 | 80.0 |
| solvent (S1) | MEDG | 80.0 | 40.0 | | | | |
| | Surface tension γ₁ (mN/m) | 27.5 | 27.2 | 26.9 | 26.9 | 26.9 | 26.9 |
| | Boiling point BP₁ (° C.) | 176 | 176 | 189 | 189 | 189 | 189 |
| Second | BTG | 14.4 | 14.4 | | 7.2 | 14.4 | 14.4 |
| solvent (S2) | MTG | | | 14.4 | 7.2 | | |
| | Surface tension γ₂ (mN/m) | 30.0 | 30.0 | 31.9 | 31.0 | 30.0 | 30.0 |
| | Boiling point BP₂ (° C.) | 271 | 271 | 249 | 271 | 271 | 271 |
| Third | EHDG | 3.6 | 3.6 | 3.6 | 3.6 | | |
| solvent (S3) | EHG | | | | | 3.6 | |
| | BFDG | | | | | | 3.6 |
| | MFTG | | | | | | |
| | HeDG | | | | | | |
| | Surface tension γ₃ (mN/m) | 25.6 | 25.6 | 25.6 | 25.6 | 25.4 | 23.7 |
| | Boiling point BP₃ (° C.) | 272 | 272 | 272 | 272 | 250 | 230 |
| Solvent | S3/(S2 + S3)*100 | 20.0 | 20.0 | 20.0 | 20.0 | 20.0 | 20.0 |
| content | S2 + S3 | 18.0 | 18.0 | 18.0 | 18.0 | 18.0 | 18.0 |
| Difference \|γ₁ - γ₃\| | | 1.9 | 1.6 | 1.3 | 1.3 | 1.5 | 3.2 |
| Difference (γ₂ - γ₁) | | 2.5 | 2.8 | 5.0 | 4.1 | 3.1 | 3.1 |
| Difference (γ₂ - γ₃) | | 4.4 | 4.4 | 6.3 | 5.4 | 4.6 | 6.3 |
| Difference (BP₂ - BP₁) | | 95.0 | 95.0 | 60.0 | 82.0 | 82.0 | 82.0 |
| Difference (BP₃ - BP₁) | | 96.0 | 96.0 | 83.0 | 83.0 | 61.0 | 41.0 |
| Evaluation | Suppression of coffee stain effect | B | B | A | A | B | B |
| result | Pattern forming properties | A | A | A | A | A | B |
| | Suppression of uneven luster | B | B | A | A | B | B |

TABLE 1 (3/4)

| Ink composition (mass %) | | Ex. 13 | Ex. 14 | Ex. 15 | Ex. 16 | Ex. 17 |
|---|---|---|---|---|---|---|
| Luster | A-1 | 1.5 | 1.5 | 1.5 | | |
| pigment | A-2 | | | | 1.2 | |
| | A-3 | | | | | 2.5 |
| Resin | Acrylic resin | 0.5 | 0.5 | 0.5 | 0.3 | 0.6 |
| First | DEDG | 80.0 | 80.0 | 80.0 | 80.5 | 78.9 |
| solvent (S1) | MEDG | | | | | |
| | Surface tension γ₁ (mN/m) | 26.9 | 26.9 | 26.9 | 26.9 | 26.9 |
| | Boiling point BP₁ (° C.) | 189 | 189 | 189 | 189 | 189 |
| Second | BTG | 14.4 | 14.4 | 14.4 | 14.4 | 14.4 |
| solvent (S2) | MTG | | | | | |
| | Surface tension γ₂ (mN/m) | 30.0 | 30.0 | 30.0 | 30.0 | 30.0 |
| | Boiling point BP₂ (° C.) | 271 | 271 | 271 | 271 | 271 |
| Third | EHDG | | | 1.8 | 3.6 | 3.6 |
| solvent (S3) | EHG | | | 1.8 | | |
| | BFDG | | | | | |
| | MFTG | 3.6 | | | | |
| | HeDG | | 3.6 | | | |
| | Surface tension γ3 (mN/m) | 25.7 | 26.0 | 25.5 | 25.6 | 25.6 |
| | Boiling point BP₃ (° C.) | 243 | 259 | 272 | 272 | 272 |
| Solvent | S3/(S2 + S3)*100 | 20.0 | 20.0 | 20.0 | 20.0 | 20.0 |
| content | S2 + S3 | 18.0 | 18.0 | 18.0 | 18.0 | 18.0 |
| Difference \|γ₁ - γ₃\| | | 1.2 | 0.9 | 1.4 | 1.3 | 1.3 |
| Difference (γ₂ - γ₁) | | 3.1 | 3.1 | 3.1 | 3.1 | 3.1 |
| Difference (γ₂ - γ₃) | | 4.3 | 4.0 | 4.5 | 4.4 | 4.4 |
| Difference (BP₂ - BP₁) | | 82.0 | 82.0 | 82.0 | 82.0 | 82.0 |
| Difference (BP₃ - BP₁) | | 54.0 | 70.0 | 83.0 | 83.0 | 83.0 |
| Evaluation | Suppression of coffee stain effect | B | B | A | B | A |
| result | Pattern forming properties | A | A | A | B | A |
| | Suppression of uneven luster | B | B | A | B | A |

TABLE 1 (4/4)

| | | Comp. | Comp. | Comp. | Comp. | Comp. |
|---|---|---|---|---|---|---|
| Ink composition (mass %) | | Ex. 1 | Ex. 2 | Ex. 3 | Ex. 4 | Ex. 5 |
| Luster | A-1 | 1.5 | 1.5 | 1.5 | 1.5 | 1.5 |
| pigment | A-2 | | | | | |
| | A-3 | | | | | |
| Resin | Acrylic resin | 0.5 | 0.5 | 0.5 | 0.5 | 0.5 |
| First | DEDG | 80.0 | 80.0 | 80.0 | 80.5 | 80.0 |
| solvent (S1) | MEDG | | | | | |
| | Surface tension γ₁ (mN/m) | 26.9 | 26.9 | 26.9 | 26.9 | 26.9 |
| | Boiling point BP₁ (° C.) | 189 | 189 | 189 | 189 | 189 |
| Second | BTG | 18.0 | 14.4 | 17.6 | | |
| solvent (S2) | MTG | | 3.6 | | | |
| | Surface tension γ₂ (mN/m) | 30.0 | 30.4 | 30.0 | | |
| | Boiling point BP₂ (° C.) | 271 | 271 | 271 | | |
| Third | EHDG | | | 0.4 | 18.0 | 3.6 |
| solvent (S3) | EHG | | | | | |
| | BFDG | | | | | 14.4 |
| | MFTG | | | | | |
| | HeDG | | | | | |
| | Surface tension γ3 (mN/m) | | | 25.6 | 25.6 | 25.6 |
| | Boiling point BP₃ (° C.) | | | 272 | 272 | 272 |
| Solvent | S3/(S2 + S3)*100 | 0.0 | 0.0 | 2.2 | 100.0 | 100.0 |
| content | S2 + S3 | 18.0 | 18.0 | 18.0 | 18.0 | 18.0 |
| Difference \|γ₁ - γ₃\| | | — | — | 1.3 | 1.3 | 1.3 |
| Difference (γ₂ - γ₁) | | 3.1 | 3.5 | 3.1 | — | — |
| Difference (γ₂ - γ₃) | | — | — | 4.4 | — | — |
| Difference (BP₂ - BP₁) | | 82.0 | 82.0 | 82.0 | — | — |
| Difference (BP₃ - BP₁) | | — | — | 83.0 | 83.0 | 83.0 |
| Evaluation | Suppression of coffee stain effect | D | D | C | B | B |
| result | Pattern forming properties | E | D | D | D | D |
| | Suppression of uneven luster | D | D | C | B | C |

The meanings of various abbreviations in Table 1 will be described hereinafter.

### Pigments

A-1: aluminum particles of Manufacturing Example 1 (volume-average particle size D₅₀=0.49 μm)

A-2: aluminum particles of Manufacturing Example 2 (volume-average particle size D₅₀=0.92 μm)

A-3: aluminum particles of Manufacturing Example 3 (volume-average particle size D₅₀=0.43 μm) Acrylic Resin

“GS-1015” (trade name) from Seiko PMC Corporation First Solvents

DEDG: diethylene glycol diethyl ether (boiling point: 189° C., surface tension: 26.9 mN/m)

MEDG: diethylene glycol ethyl methyl ether (boiling point: 176° C., surface tension: 27.5 mN/m) Second Solvents

BTG: triethylene glycol monobutyl ether (boiling point: 271° C., surface tension: 30.0 mN/m)

MTG: triethylene glycol monomethyl ether (boiling point: 249° C., surface tension: 31.9 mN/m)

### Third Solvents

EHDG: diethylene glycol mono-2-ethylhexyl ether (boiling point: 272° C., surface tension: 25.6 mN/m)

EHG: ethylene glycol mono-2-ethylhexyl ether (boiling point: 250° C., surface tension: 25.4 mN/m)

BFDG: dipropylene glycol monobutyl ether (boiling point: 230° C., surface tension: 23.7 mN/m)

MFTG: tripropylene glycol monomethyl ether (boiling point: 243° C., surface tension: 25.7 mN/m)

HeDG: diethylene glycol monohexyl ether (boiling point: 259° C., surface tension: 26.0 mN/m)

As shown in the results of the Examples and Comparative Examples, the ink compositions of the present embodiment further suppress the coffee stain effect and uneven luster of images as well as exhibit further excellent pattern forming properties.

The comparison of the results between Example 1 and Comparative Examples 1, 2, 4, and 5 reveals that the ink composition of the present embodiment can obtain an excellent result concerning the coffee stain effect by including the first solvent, the second solvent, and the third solvent. Moreover, it is also revealed that the ink composition of Example 1 is excellent in pattern forming properties and in suppression of uneven luster compared with the ink compositions of Comparative Examples 1, 2, 4, and 5.

The comparison of the results between Examples 1 to 4 and Comparative Example 3 reveals that the ink compositions of the present embodiment are excellent in pattern forming properties and in suppression of the coffee stain effect as well as uneven luster by including the first solvent, the second solvent, and the third solvent as well as by controlling the content of the third solvent to 5.0% by mass or more and 92.0% by mass or less based on the total content of the second solvent and the third solvent.

The results of Examples 5 and 6 reveal that the ink compositions of the present embodiment are excellent in pattern forming properties and in suppression of the coffee stain effect as well as uneven luster by controlling the total content of the second solvent and the third solvent to 12.0% by mass or more and 30.0% by mass or less based on the total mass of each ink composition.

The results of Examples 1, 7, and 8 reveal that the ink compositions of the present embodiment are also excellent in pattern forming properties and in suppression of the coffee stain effect as well as uneven luster when another solvent or a combination thereof is used as the first solvent.

The results of Examples 1, 9, and 10 reveal that the ink compositions of the present embodiment are also excellent in pattern forming properties and in suppression of the coffee stain effect as well as uneven luster when another solvent or a combination thereof is used as the second solvent.

The results of Examples 1 and 11 to 15 reveal that the ink compositions of the present embodiment are also excellent in pattern forming properties and in suppression of the coffee stain effect as well as uneven luster when various solvents are used as the third solvent.

The results of Examples 1, 16, and 17 reveal that the ink compositions of the present embodiment are also excellent in pattern forming properties and in suppression of the coffee stain effect as well as uneven luster when various luster pigments are used.

What is claimed is:

1. A solvent-based ink composition comprising:
a luster pigment;
a first solvent having a boiling point of 200° C. or lower and a surface tension γ₁ of 28.0 mN/m or less;
a second solvent having a boiling point of higher than 200° C. and a surface tension γ₂ of more than 28.0 mN/m; and
one or more third solvents having a boiling point of higher than 200° C. and a surface tension γ₃ of 28.0 mN/m or less; wherein
a content of the third solvents is 5.0% by mass or more and 92.0% by mass or less based on a total content of the second solvent and the third solvents.

2. The solvent-based ink composition according to claim 1, wherein
the third solvents include one or more selected from the group consisting of ethylene glycol mono-2-ethylhexyl ether, diethylene glycol monohexyl ether, diethylene glycol mono-2-ethylhexyl ether, dipropylene glycol monobutyl ether, and tripropylene glycol monomethyl ether.

3. The solvent-based ink composition according to claim 1, wherein the luster pigment contains aluminum.

4. The solvent-based ink composition according to claim 1, wherein the luster pigment has a volume-average particle size D₅₀ of 0.20 μm or more and 1.00 μm or less.

5. The solvent-based ink composition according to claim 1, wherein the surface tension γ₃ is smaller than the surface tension γ₁.

6. The solvent-based ink composition according to claim 1, wherein the boiling point BP₃ of the third solvent is higher than the boiling point BP₂ of the second solvent.

7. The solvent-based ink composition according to claim 1, wherein an absolute value |γ₁−γ₃| of a difference between the surface tension γ₁ and the surface tension γ₃ is 3.5 mN/m or less.

8. The solvent-based ink composition according to claim 1, wherein a difference (γ₂−γ₁) between the surface tension γ₂ and the surface tension γ₁ is 3.0 mN/m or more.

9. The solvent-based ink composition according to claim 1, wherein a difference (γ₂−γ₃) between the surface tension γ₂ and the surface tension γ₃ is 5.0 mN/m or more.

10. The solvent-based ink composition according to claim 1, wherein a difference (BP₂−BP₁) between the boiling point BP₂ of the second solvent and the boiling point BP₁ of the first solvent is 50.0° C. or more.

11. The solvent-based ink composition according to claim 1, wherein a difference (BP₃−BP₁) between the boiling point BP₃ and the boiling point BP₁ of the first solvent is 30.0° C. or more.
